(19) United States
(12) Patent Application Publication
(10) Pub. No.: US 2024/0090078 A1
(43) Pub. Date: Mar. 14, 2024

(54) MULTICAST BROADCAST SERVICES IN 5G SYSTEMS

(71) Applicant: NOKIA SOLUTIONS AND NETWORKS OY, Espoo (FI)

(72) Inventor: Philippe GODIN, Versailles (FR)

(21) Appl. No.: 18/275,248

(22) PCT Filed: Mar. 2, 2021
(86) PCT No.: PCT/EP2021/055150

§ 371 Date: Aug. 1, 2023

(51) Int. Cl. H04W 76/40

(52) U.S. Cl. CPC H04W 76/40

(57) ABSTRACT

An apparatus in a source radio access node comprises means for receiving first information for determining a last packet to be forwarded to a target radio access node to which a communications device is being handed over from the source radio access node, said source radio access node providing a multicast or broadcasting service to the communications device. The means may be for causing the last packet to be forwarded from the source radio access node to the target radio access node with end information indicating that there no further packets are being forwarded.

### FIELD

The present application relates to a method, apparatus, system and computer program and in particular but not exclusively to a method apparatus, system and computer program which supports a multicast or broadcasting service.

### BACKGROUND

A communication system can be seen as a facility that enables communication sessions between two or more entities such as user communication devices, base stations and/or other nodes by providing carriers between the various entities involved in the communications path. A communication system can be provided for example by means of a communication network and one or more compatible communication devices. The communication sessions may comprise, for example, communication of data for carrying communications such as voice, video, electronic mail (email), text message, multimedia and/or content data and so on. The service may include broadcast or multicast services.

In a wireless communication system at least a part of a communication session between at least two stations occurs over a wireless link. Examples of wireless systems comprise public land mobile networks (PLMN), satellite based communication systems and different wireless local networks, for example wireless local area networks (WLAN). Some wireless systems can be divided into cells, and are therefore often referred to as cellular systems.

A user can access the communication system by means of an appropriate communication device or terminal. A communication device of a user may be referred to as user equipment (UE) or user device. A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. One example of a communications system is UTRAN (3G radio). Other examples of communication systems are the long-term evolution (LTE) of the Universal Mobile Telecommunications System (UMTS) radio-access technology and so-called 5G or New Radio (NR) networks. NR is being standardized by the 3rd Generation Partnership Project (3GPP).

### SUMMARY

According to an aspect there is provided an apparatus in a source radio access node, said apparatus comprising means for: receiving first information for determining a last packet to be forwarded to a target radio access node to which a communications device is being handed over from the source radio access node, said source radio access node providing a multicast or broadcasting service to the communications device; and causing the last packet to be forwarded from the source radio access node to the target radio access node with end information indicating that there no further packets are being forwarded.

The means may be for receiving at the source radio access node via a multicast shared tunnel for a multicast or broadcasting service session one or more packets to be forwarded to the target radio access node.

The means may be for receiving the first information at the source radio access node via a unicast tunnel which is associated with a multicast shared tunnel corresponding to the same multicast or broadcasting service session.

The means may be for receiving at the source radio access node one or more packets to be forwarded to the target radio access node via a multicast shared tunnel for a multicast or broadcasting service session and for receiving the first information at the source radio access node via a unicast tunnel which is associated with a multicast shared channel corresponding to the same multicast or broadcasting service session

The first information may comprise an end marker.

The first information may comprise a sequence number.

The first information may comprise information indicating a first packet which is directly sent to the target radio access node.

The means may be for determining a packet having a sequence number preceding a sequence number of the first packet as the last packet to be forwarded.

The end information may comprise one or more end marker packets.

The target radio access node may not support a multicast or broadcast service.

According to another aspect, there is provided an apparatus in a source radio access node, the apparatus comprising at least one processor and at least one memory including a computer program code, the at least one memory and computer program code configured to, with the at least one processor, cause the apparatus at least to: receive first information for determining a last packet to be forwarded to a target radio access node to which a communications device is being handed over from the source radio access node, said source radio access node providing a multicast or broadcasting service to the communications device; and causing the last packet to be forwarded from the source radio access node to the target radio access node with end information indicating that there no further packets are being forwarded.

The at least one memory and at least one processor may be configured to cause the apparatus to receive at the source radio access node via a multicast shared tunnel for a multicast or broadcasting service session one or more packets to be forwarded to the target radio access node.

The at least one memory and at least one processor may be configured to cause the apparatus to receive the first information at the source radio access node via a unicast tunnel which is associated with a multicast shared tunnel corresponding to the same multicast or broadcasting service session.

The at least one memory and at least one processor may be configured to cause the apparatus to receive at the source radio access node one or more packets to be forwarded to the target radio access node via a multicast shared tunnel for a multicast or broadcasting service session and receive the first information at the source radio access node via a unicast tunnel which is associated with a multicast shared channel corresponding to the same multicast or broadcasting service session

The first information may comprise an end marker.

The first information may comprise a sequence number.

The first information may comprise information indicating a first packet which is directly sent to the target radio access node.

The at least one memory and at least one processor may be configured to cause the apparatus to determine a packet having a sequence number preceding a sequence number of the first packet as the last packet to be forwarded.

The end information may comprise one or more end marker packets.

The target radio access node may not support a multicast or broadcast service.

According to an aspect there is provided a method comprising: receiving, at a source radio access node, first information for determining a last packet to be forwarded to a target radio access node to which a communications device is being handed over from the source radio access node, said source radio access node providing a multicast or broadcasting service to the communications device; and causing the last packet to be forwarded from the source radio access node to the target radio access node with end information indicating that there no further packets are being forwarded.

The method may comprise receiving at the source radio access node via a multicast shared tunnel for a multicast or broadcasting service session one or more packets to be forwarded to the target radio access node.

The method may comprise receiving the first information at the source radio access node via a unicast tunnel which is associated with a multicast shared tunnel corresponding to the same multicast or broadcasting service session.

The method may comprise receiving at the source radio access node one or more packets to be forwarded to the target radio access node via a multicast shared tunnel for a multicast or broadcasting service session and for receiving the first information at the source radio access node via a unicast tunnel which is associated with a multicast shared channel corresponding to the same multicast or broadcasting service session

The first information may comprise an end marker.

The first information may comprise a sequence number.

The first information may comprise information indicating a first packet which is directly sent to the target radio access node.

The method may comprise determining a packet having a sequence number preceding a sequence number of the first packet as the last packet to be forwarded.

The end information may comprise one or more end marker packets.

The target radio access node may not support a multicast or broadcast service.

According to another aspect, there is provided an apparatus in a user plane function node, said apparatus comprising means for: receiving a first multicast packet from a multicast broadcast user plane function to be delivered to a target radio access node not supporting a multicast or broadcast service over a unicast tunnel; and providing an end marker packet to be delivered to a source radio access node supporting a multicast or broadcast service over a unicast tunnel which is associated with a multicast shared tunnel set up for that multicast or broadcast service.

The first multicast packet may be associated with a first sequence number corresponding to a sequence number of a duplicate multicast packet delivered by the multicast broadcast user plane function directly over the multicast shared tunnel.

The means may be for providing the end marker packet with information about the first sequence number.

According to an aspect, there is provided an apparatus in a user plane function node, the apparatus comprising at least one processor and at least one memory including a computer program code, the at least one memory and computer program code configured to, with the at least one processor, cause the apparatus at least to: receive a first multicast packet from a multicast broadcast user plane function to be delivered to a target radio access node not supporting a multicast or broadcast service over a unicast tunnel; and provide an end marker packet to be delivered to a source radio access node supporting a multicast or broadcast service over a unicast tunnel which is associated with a multicast shared tunnel set up for that multicast or broadcast service.

The first multicast packet may be associated with a first sequence number corresponding to a sequence number of a duplicate multicast packet delivered by the multicast broadcast user plane function directly over the multicast shared tunnel.

The at least one memory and at least one processor may be configured to cause the apparatus to provide the end marker packet with information about the first sequence number.

According to another aspect, there is provided a method comprising: receiving, at user plane function node, a first multicast packet from a multicast broadcast user plane function to be delivered to a target radio access node not supporting a multicast or broadcast service over a unicast tunnel; and providing an end marker packet to be delivered to a source radio access node supporting a multicast or broadcast service over a unicast tunnel which is associated with a multicast shared tunnel set up for that multicast or broadcast service.

The first multicast packet may be associated with a first sequence number corresponding to a sequence number of a duplicate multicast packet delivered by the multicast broadcast user plane function directly over the multicast shared tunnel.

The method may comprise providing the end marker packet with information about the first sequence number.

According to another aspect, there is provided an apparatus in a target radio access node, said apparatus comprising means for: receiving unicast packets having a respective sequence number, the unicast packet being associated with a unicast from a source radio access node to a communication device, the communication device being handed over from the source radio access node to the target radio access node, said target radio access node providing a multicast or broadcasting service to the communications device; and receiving multicast packets having a respective sequence number for the communication device; and using the sequence number of the unicast packets and the multicast packets to determine duplicate packets.

The means may be for determining that the communication device has been configured to receive the multicast or broadcast service and for causing the delivery of the unicast packet to be stopped.

The source radio access node may not support a multicast or broadcast service.

According to another aspect, there is provided an apparatus in a target radio access node, the apparatus comprising at least one processor and at least one memory including a computer program code, the at least one memory and computer program code configured to, with the at least one processor, cause the apparatus at least to: receive unicast packets having a respective sequence number, the unicast packet being associated with a unicast from a source radio access node to a communication device, the communication device being handed over from the source radio access node to the target radio access node, said target radio access node providing a multicast or broadcasting service to the communications device; receive multicast packets having a respective sequence number for the communication device; and use the sequence number of the unicast packets and the multicast packets to determine duplicate packets.

The at least one memory and at least one processor may be configured to cause the apparatus to determine that the communication device has been configured to receive the multicast or broadcast service and for causing the delivery of the unicast packet to be stopped.

The source radio access node may not support a multicast or broadcast service.

According to another aspect, there is provided a method comprising: receiving, in a target radio access node, unicast packets having a respective sequence number, the unicast packet being associated with a unicast from a source radio access node to a communication device, the communication device being handed over from the source radio access node to the target radio access node, said target radio access node providing a multicast or broadcasting service to the communications device; receiving multicast packets having a respective sequence number for the communication device; and using the sequence number of the unicast packets and the multicast packets to determine duplicate packets.

The method may comprise determining that the communication device has been configured to receive the multicast or broadcast service and for causing the delivery of the unicast packet to be stopped.

The source radio access node may not support a multicast or broadcast service.

According to an aspect, there is provided an apparatus in a user plane function node, said apparatus comprising means for: receiving multicast packets from a multicast broadcast user plane function to be delivered to a target radio access node supporting a multicast or broadcast service over a unicast tunnel; receiving the multicast packets with a sequence number corresponding to a duplicate packet sent by the multicast broadcast user plane function over a multicast shared tunnel setup for that multicast or broadcast service; and causing the multicast packets to be sent over the unicast tunnel to the target radio access node with the sequence number.

The source radio access node may not support a multicast or broadcast service.

The means may be for stopping multicast packets from being sent over the unicast tunnel in response to receiving a notification from the target radio access node.

According to an aspect, there is provided an apparatus in a user plane function node, the apparatus comprising at least one processor and at least one memory including a computer program code, the at least one memory and computer program code configured to, with the at least one processor, cause the apparatus at least to: receive multicast packets from a multicast broadcast user plane function to be delivered to a target radio access node supporting a multicast or broadcast service over a unicast tunnel; receive the multicast packets with a sequence number corresponding to a duplicate packet sent by the multicast broadcast user plane function over a multicast shared tunnel setup for that multicast or broadcast service; and cause the multicast packets to be sent over the unicast tunnel to the target radio access node with the sequence number.

The source radio access node may not support a multicast or broadcast service.

The at least one memory and at least one processor may be configured to cause the apparatus to stop multicast packets from being sent over the unicast tunnel in response to receiving a notification from the target radio access node.

According to an aspect, there is provided a method comprising: receiving, in a user plane function node, multicast packets from a multicast broadcast user plane function to be delivered to a target radio access node supporting a multicast or broadcast service over a unicast tunnel; receiving the multicast packets with a sequence number corresponding to a duplicate packet sent by the multicast broadcast user plane function over a multicast shared tunnel setup for that multicast or broadcast service; and causing the multicast packets to be sent over the unicast tunnel to the target radio access node with the sequence number.

The source radio access node may not support a multicast or broadcast service.

The means may be for stopping multicast packets from being sent over the unicast tunnel in response to receiving a notification from the target radio access node.

According to an aspect, there is provided a computer readable medium comprising program instructions for causing an apparatus to perform at least the following

According to an aspect, there is provided a non-transitory computer readable medium comprising program instructions for causing an apparatus to perform at least the method according to any of the preceding aspects.

In the above, many different examples have been described. It should be appreciated that further examples may be provided by the combination of any two or more of the examples described above.

### DESCRIPTION OF FIGURES

Examples will now be described, by way of example only, with reference to the accompanying Figures in which:

FIG. 1 shows a representation of a network system according to some examples;

FIG. 2 shows a representation of a control apparatus according to some examples;

FIG. 3 shows a representation of an apparatus according to some examples;

FIG. 4 shows a signal flow according to some examples;

FIG. 5 shows another signal flow according to some examples;

FIG. 6 shows a first method according to some examples;

FIG. 7 shows a second method according to some examples;

FIG. 8 shows a third method according to some examples;

FIG. 9 shows a fourth method according to some examples; and

FIG. 10 shows a schematic representation of a non-volatile memory medium storing instructions which when executed by a processor allow a processor to perform one or more of the steps of the methods of some embodiments

### DETAILED DESCRIPTION

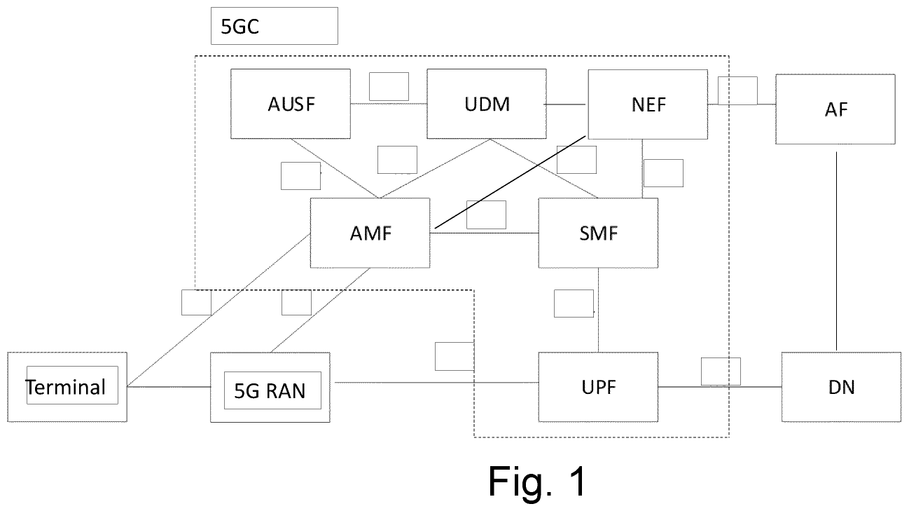

In the following certain examples are explained with reference to mobile communication devices capable of communication via a wireless cellular system and mobile communication systems serving such mobile communication devices. Before explaining in detail the examples, certain general principles of a wireless communication system, access systems thereof, and mobile communication devices are briefly explained with reference to FIGS. 1, 2 and 3 to assist in understanding the technology underlying the described examples.

FIG. 1 shows a schematic representation of a 5G system (5GS). The 5GS may be comprised by a communication device or user equipment (UE), a 5G radio access network (5GRAN) or next generation radio access network (NG-RAN), a 5G core network (5GC), one or more application function (AF) and one or more data networks (DN).

The 5G may be used for mobile access or for fixed access. The 5GC may comprise an access management function (AMF), a session management function (SMF), an authentication server function (AUSF), a user data management (UDM), a user plane function (UPF) and/or a network exposure function (NEF). Although not illustrated the 5GC may comprise other network functions (NF), such as an unstructured data storage function (UDSF).

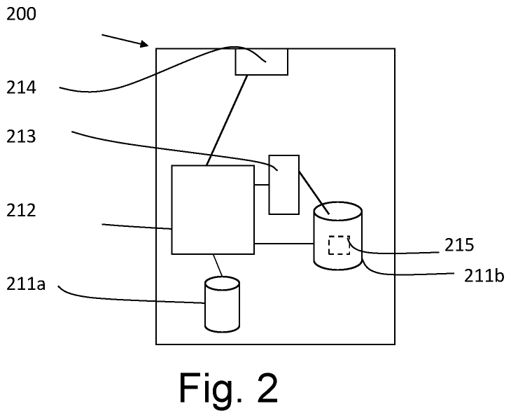

FIG. 2 illustrates an example of an apparatus 200. The apparatus may comprise at least one memory. By way of example only the memory may comprise random access memory (RAM) 211a and/or at least on read only memory (ROM) 211b. In other embodiments, the memory may alternatively or additionally be provided by any other suitable apparatus. The apparatus may comprise at least one processor 212, 213. The apparatus may comprise an input/output interface 214. The at least one processor may be coupled to the at least one memory. The at least one processor may be configured to execute an appropriate software code 215. The software code 215 may for example allow to perform one or more steps to perform one or more of the present aspects. The software code 215 may be stored in the at least one memory. By way of example only, the software code may be stored in the ROM 211b. The apparatus may be provided in an MBS supporting RAN node or base station.

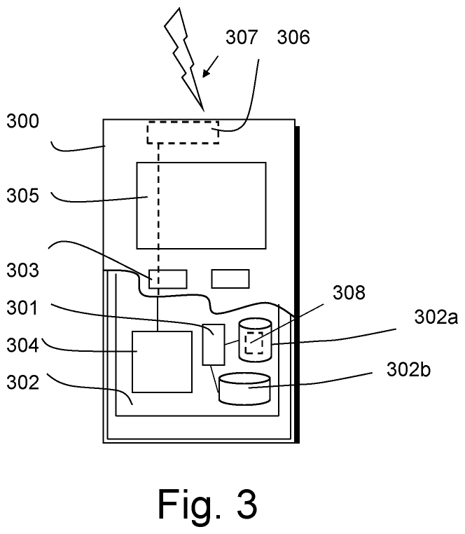

FIG. 3 illustrates an example of a communication device 300, such as the communication device illustrated on FIG. 1. The communication device 300 may be provided by any device capable of sending and receiving radio signals. Non-limiting examples comprise a user equipment, a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, an Internet of things (loT) type communication device or any combinations of these or the like. The communication device 300 may provide, for example, communication of data for carrying communications. The communications may be one or more of voice, electronic mail (email), text message, multimedia, data, machine data and so on.

The communication device 300 may receive signals over an air or radio interface 307 via appropriate apparatus for receiving and may transmit signals via appropriate apparatus for transmitting radio signals. In FIG. 3 transceiver apparatus is designated schematically by block 306. The transceiver apparatus 306 may be provided for example by means of a radio part and associated antenna arrangement. The antenna arrangement may be arranged internally or externally to the mobile device.

The communication device 300 may be provided with at least one processor 301, at least one memory ROM 302a, at least one RAM 302b and other possible components for use in software and hardware aided execution of tasks it is designed to perform, including control of access to and communications with access systems and other communication devices. The at least one processor 301 is coupled to the RAM 311a and the ROM 311b. The at least one processor 301 may be configured to execute an appropriate software code 308. The software code 308 may for example allow to perform one or more of the present aspects. The software code 308 may be stored in the ROM 311b.

The processor, storage and other relevant control apparatus can be provided on an appropriate circuit board and/or in chipsets. This feature is denoted by reference 304. The device may optionally have a user interface such as keypad 305, touch sensitive screen or pad, combinations thereof or the like. Optionally one or more of a display, a speaker and a microphone may be provided depending on the type of the device.

In some examples, an access node of the network may be configured to provide a multicast or broadcast service (MBS) towards UEs.

In the case of a broadcast service, a same service and same specific content data can be provided simultaneously to the communication devices in a coverage area of the access node. In the case of a multicast service, a same service and same specific content data can be provided to those communication devices which have joined to the multicast service.

Some embodiments may relate to the continuation of an MBS service when a communications devices moves from one RAN node to another. This RAN node may be an gNodeB, a NR node or any other suitable node.

When a communication device moves from one node to another, one of the following cases may apply:
communication device moves from an MBS supporting node to an MBS supporting node (case 1)
communication device moves from an MBS supporting node to a non-MBS supporting node (case 2)
communication device moves from a non-MBS supporting node to an MBS supporting node (case 3)

A non MBS supporting node may be a legacy node or a node that does not support a MBS service.

When the communication device operates under an MBS supporting node, a MBS shared delivery mode can be used wherein the MBS data is delivered over an N3 shared tunnel to the RAN and over a radio MRB (multicast radio bearer). The RAN node may use a PTM (point to multipoint) mode where the data is destined to multiple communication devices at same time and not only one communication device. The N3 shared tunnel is between the UPF and the RAN.

In order to support the mobility for case (1), it has been considered in 3GPP RAN2/RAN3 to synchronize the source and target cell MRB PDCP (packet data convergence protocol) SN (sequence number) by using a CN (core network) generated MBS-SN over the N3 shared tunnel. This solution can be used between two MBS supporting NG-RAN nodes supporting N3 shared tunnels and MRB PDCP—that is case 1.

In case (2), for a communication device moving from a MBS supporting RAN node to non-MBS supporting (i.e. legacy) RAN node, the data can be delivered at the source via the N3 shared tunnel. However, the legacy target RAN node does not support a N3 shared tunnel but rather a legacy unicast N3 tunnel. Some embodiments may provide a method where there is delivery of data from the shared tunnel and then via the unicast tunnel without data loss or minimizing data loss.

Similarly, in case (3), for a communication device moving from a non-MBS supporting (legacy) MBS RAN node to an MBS supporting RAN node, the data will stop being delivered via the unicast tunnel and start being delivered via the shared tunnel. Some embodiments may provide a method where there is delivery of data from the unicast tunnel and then via the shared tunnel without data loss or minimizing data loss.

One of the challenges addressed by some embodiments, is that the PDCP SN (sequence numbers) are not synchronized between the MRB PDCP of the MBS-supporting cell operating in MBS shared delivery, and the DRB (dedicated radio bearer) PDCP set up for the communication device in the non MBS supporting cell.

Some embodiments may address cases (2) and/or (3). Some embodiments may aim to minimize data loss in such cases. In some embodiments, cases (2) and/or (3) may involve a non-MBS supporting RAN node using N3 unicast and a DRB (dedicated radio bearer) PDCP. A unicast QoS (quality of service) flow may be associated to each MBS flow in an MBS supporting RAN node. This may be used in some embodiments. Some embodiments may provide a network based approach to minimize data loss in cases (2) and/or (3). Some embodiments may aim to reduce the impact on the communication device.

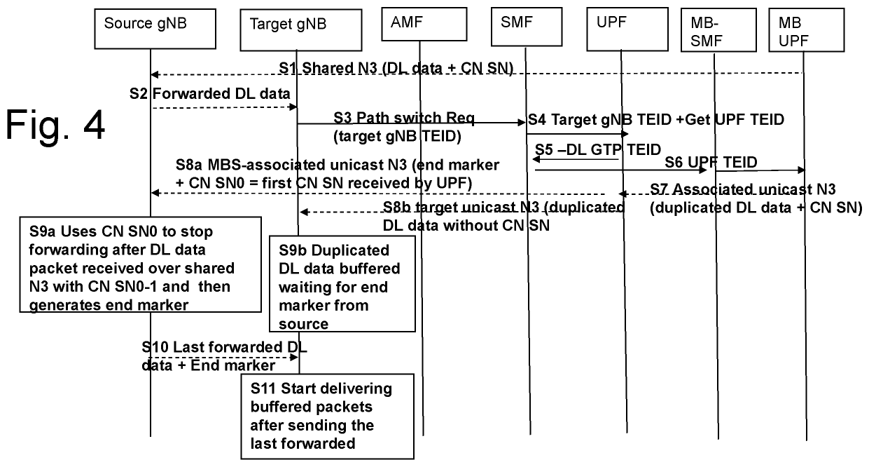

Reference is made to FIG. 4 which shows an example of the signal flow for case 2, that is where the communication device moves from an MBS supporting node to a non-MBS supporting node. In this example, the switch from MBS shared delivery at the source RAN node to unicast delivery at the target RAN node happens as a result of the path switch request.

In step S1, the MB UPF is configured to provide MBS DL (downlink) data and the CN (core node) SN (sequence number) for that data to the source RAN node which is currently servicing the communication device. That data is provided via a shared N3 tunnel. Each packet may be provided with a respective SN. The providing of data via the mechanism of step S1 is ongoing and takes palace in parallel with other of the steps which are described below.

In step S2, the source RAN node forwards the DL data received over the shared tunnel to the non MBS supporting target gNB over a forwarding tunnel.

In step S3, the non MBS supporting target gNB sends a path switch request with the target RAN node TEID (of the unicast tunnel) to the SMF.

In step S4, the SMF sends to the UPF the DL RAN TEID of the unicast tunnel of target gNB, and requests that the UPF deliver of multicast packets incoming from MB-UPF over that unicast tunnel to the target RAN node. The request may also include a request to the UPF to provide a TEID (tunnel endpoint identifier) for the unicast tunnel between the MB-UPF and the UPF in the case that the tunnel does not already exist (for the delivery to other UEs).

The delivery from MB-UPF to UPF may be via a “shared” tunnel (i.e. for several UEs) in some embodiments. In the case of a shared tunnel, the request from the SMF may or may not have a UPF TEID request. In some embodiments, the delivery from MB-UPF to UPF may be via a “dedicated” tunnel, that is for one UE. In the case of a dedicated tunnel, the request from the SMF contains a UPF TEID request.

In step S5, the UPF acknowledges the request of the SMF and includes the requested UPF DL GTP TEID when the SMF has requested this.

In step S6, the SMF forwards the UPF DL GTP TEID to the MB-UPF via the MB-SMF when applicable. This is so the MB-UPF can start sending MBS unicast packets to the UPF which are destined to the target RAN node.

In step S7, the MB-UPF sends the multicast packets (or at least first one of the multicast packets) to the UPF with the CN SN normally used over N3 shared tunnel. The first packet sequence number is referred to as the CN sequence number SN0. This may be sent with an end marker.

In step S8a, the UPF uses the CN sequence number SN0 received with the first packet from the MB-UPF to generate an end marker packet for the source RAN node. The UPF sends the end marker packet over the associated unicast N3 tunnel of the unicast QoS flow associated with the MBS QoS flow along with the CN sequence number SN0. The source RAN node is MBS supporting: it will have an N3 shared tunnel (for all UEs) for the MBS session plus one associated unicast N3 tunnel per UE for the MBS session. Target RAN node is a non MBS supporting node: it will have only a unicast tunnel (per UE).

In step S8b, which may take place at least partially in parallel with step S8a, the UPF provides to the target RAN node a duplicate of the downlink data via the unicast N3 tunnel which is also provided to other communication devices via the multicast tunnel. This duplicated data is without the CN sequence numbers. The packet sent over S8b is a duplicate of a packet sent in S1. This means that MB-UPF sends each multicast packet directly over the shared N3 to source RAN node (S1), and a duplicate to UPF (in S7) which UPF forwards to target gNB (in S8b).

In step S9a, at the source side, the source RAN node continuously receive packets over the shared N3 tunnel which each have a CN SN. The source RAN node has setup a unicast forwarding tunnel towards the target RAN node. This unicast tunnel is used by the source RAN node to forward the packets received over the source shared N3 tunnel to the target RAN node. The source NG-RAN node uses the CN sequence number SN0 received over the N3 unicast tunnel from the UPF to understand which packet received over the shared N3 tunnel (from the MB-UPF) is the last packet to be forwarded. In other words, the last packet which has been received over the shared N3 and which is to be forwarded to the target RAN node is the packet with CN SN equal to SN0-1. (the packet preceding the packet with the sequence number SN0). After forwarding the packet of CN sequence number SN0-1, the source NG-RAN node generates an end marker packet.

In step S9b, which may happen at least partially in parallel with step S9a, the target RAN node buffers the duplicated downlink data received from the UPF via the unicast N3 tunnel. This will start from the packet associated with the sequence number SN0.

In step S10, the source RAN node forwards the end marker packet to the target RAN node.

In step S11, the target RAN node uses the received end marker packet to determine that no more forwarded packets are to be expected from the source RAN and it can start delivering the fresh packets which it has received from UPF in step S8b to the respective communications device. This operation is a legacy operation which means that target RAN node can be a legacy R15/R16 node.

In some embodiments, the arbitration between the forwarded packets from the source RAN and the packets received at the target RAN node via the N3 unicast tunnel is done on the RAN side. This may mean that no change in the behaviour of the communications device is required.

In some embodiments, the modifications required are on the source RAN node side. This is configured to be MBMS capable. The changes required to support some embodiments may impact on the source RAN node which is MBS capable. No change may be required to the target RAN node. Thus where the target RAN nodes is a legacy node, no change to the target RAN node is required.

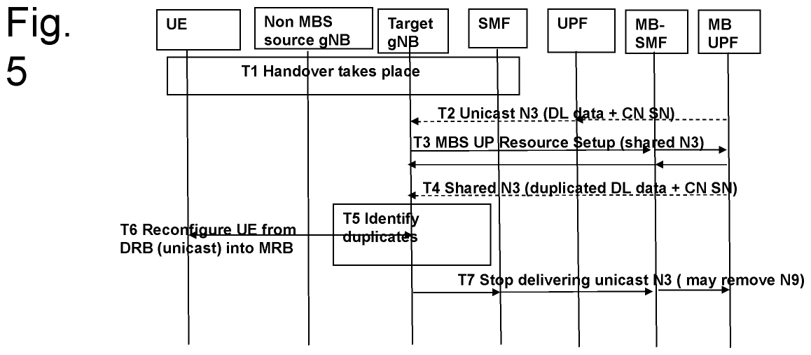

Refence is made to FIG. 5 which shows an example of the signal flow for case 3, that is where the communication device moves or is handed over from a non MBS supporting node to an MBS supporting node.

Case (3) is where a handover takes place so that the multicast data is delivered over unicast QoS flow at the target side in an “individual delivery mode”. Then the target side switches from “individual delivery” mode (unicast N3) to “shared delivery mode” (using shared N3).

Some embodiments aim to minimize packet loss during the switch from “individual delivery mode” to “shared delivery mode”. In some embodiments, the CN SN delivered over the shared N3 is used for the delivery of packets over the unicast N3 (which corresponds to the unicast QoS flow associated with the MBS QoS flow).

In step T1, the handover of the UE from the non MBS source RAN node to MBS target RAN node takes place. As part of this procedure, the target RAN node triggers the shared N3 user plane setup procedure towards the MB-SMF (if not already setup) to receive the DL data directly from the MB-UPF, only in case this shared N3 tunnel does not yet exists.

In step T2, the MB-UPF provides the DL data with the CN SN via the UPF and via the N3 unicast tunnel down to the target RAN node. A source legacy RAN may use a legacy forwarding tunnel to the target RAN node and for that transition the legacy data duplication avoidance in the target RAN can be used: i.e. PDCP SN based between the forwarding tunnel from the source RAN node and the unicast N3 tunnel from the UPF.

As will be described in more detail, after this forwarding and this handover, the target RAN node will trigger a switch (at CN) from the unicast N3 tunnel into the shared N3 tunnel for this communication device. For that switch, the packets delivered to the target RAN node over unicast N3 include the CN SN so that the target RAN node can avoid duplication with the packets received at same time over the shared N3 tunnel. In other embodiments, the switch at the CN may be in the CN in any suitable manner. In step T3, the target RAN node triggers the shared N3 user plane setup procedure towards the MB-SMF (if not already setup) to receive the DL data directly from the MB-UPF. This involves a set up message being sent from the target RAN node to the MB-UPF via the MB-SMF. The MB-SMF provides a set up response to the target RAN node via the MB-SMF.

In step T4, the MB-UPF send the duplicated DL data with the CN SN via the shared N3 tunnel to the target RAN node.

In step T5, the target RAN node is able to identify duplicate packet which are received over both the unicast and shared N3 tunnels. This may take at least partially in parallel with step T6.

In step T6, the target RAN node can reconfigure the UE from receiving the data from the unicast DRB (associated with unicast N3 tunnel) into receiving the MRB (associated with the shared N3 tunnel). The target gNB is able to ensure service continuity, minimization of data loss and no duplicates because both the packets received over the unicast N3 tunnel and the packets received over the shared N3 tunnel have an associated CN SN.

For example, consider the example where the target RAN node starts reconfiguring the UE (from DRB to MRB) at the point in time when it receives packet CN SN=100 over the unicast N3. The target RAN node starts buffering the MRB PDCP SDUs (service data units) corresponding that CN SN=100 in a buffer dedicated for that particular UE in a precursor to the radio PtP (point to point) mode. In the meantime target RAN node reconfigures the UE into the MRB PtP mode. After the reconfiguration, the target RAN node delivers the buffered packets to the UE in PtP mode until the UE catches with ongoing MRB delivery for all UEs. At this point in time target gNB may either continue in MRB PtP mode or switch to MRB PtM (point to multipoint) mode for that communication device as part of the PtP/PtM switch.

In step T7, after the reconfiguration of the UE, the target RAN node can discard packets of unicast N3 tunnel and send a trigger or request to the SMF to request the UPF via the SMF to stop the delivery of packets over the unicast N3 tunnel. This message may further be sent to the MB-UPF via the MB-SMF to remove N9 tunnel. This may message may be sent, only if needed. This may depend on the N9 tunnel is a shared or a dedicated tunnel.

The N3 unicast tunnel may be removed or retained. It is typically kept as unicast tunnel associated to the MBS shared tunnel for that MBS session.

The arbitration between forwarded packets and fresh packets at the target side is done by the target RAN node which is MBS supporting. This may have no impact on the communication device or the source RAN node which is non MBS RAN node. The source non MBS node may be a legacy node and need no modifications to be used with some embodiments.

The RAN nodes may be gNB or NG-RAN nodes or any other suitable access point nodes.

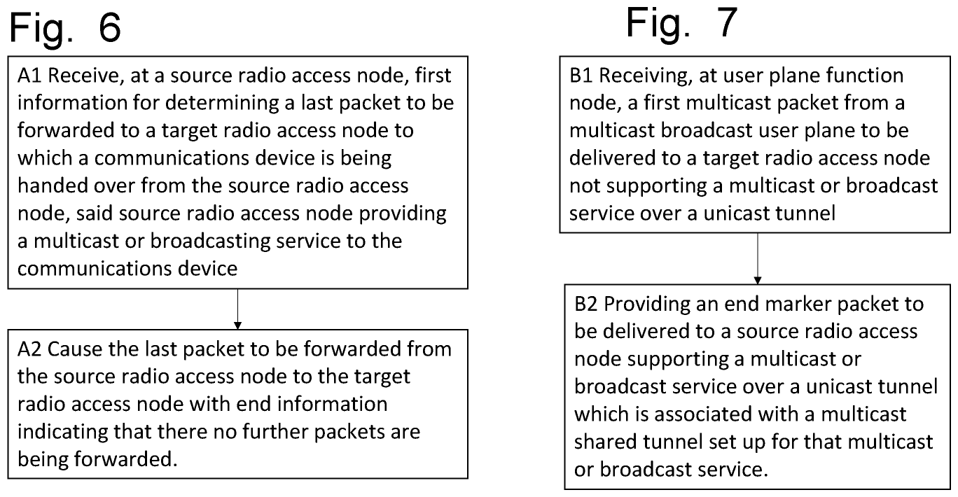

Reference is made to FIG. 6 which shows a method. The method may be performed by an apparatus. This apparatus may be as described in relation to FIG. 2. The apparatus may be provided by or in a source radio access node.

The method comprises in A1 receiving, at a source radio access node, first information for determining a last packet to be forwarded to a target radio access node to which a communications device is being handed over from the source radio access node, said source radio access node providing a multicast or broadcasting service to the communications device.

The method comprises in A2 causing the last packet to be forwarded from the source radio access node to the target radio access node with end information indicating that there no further packets are being forwarded.

Reference is made to FIG. 7 which shows a method. The method may be performed by an apparatus. This apparatus may be as described in relation to FIG. 2. The apparatus may be provided by or in a user plane function node.

The method comprises in B1 receiving, at user plane function node, a first multicast packet from a multicast broadcast user plane function to be delivered to a target radio access node not supporting a multicast or broadcast service over a unicast tunnel.

The method comprises in B2 providing an end marker packet to be delivered to a source radio access node supporting a multicast or broadcast service over a unicast tunnel which is associated with a multicast shared tunnel set up for that multicast or broadcast service.

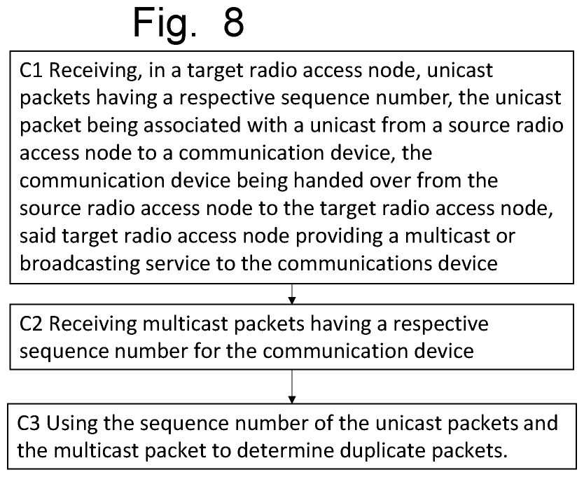

Reference is made to FIG. 8 which shows a method. The method may be performed by an apparatus. This apparatus may be as described in relation to FIG. 2. The apparatus may be provided by or in a target radio access node.

The method comprises in C1 receiving unicast packets having a respective sequence number. The unicast packet is associated with a unicast from a source radio access node to a communication device. The communication device is being handed over from the source radio access node to the target radio access node. The target radio access node provides a multicast or broadcasting service to the communications device.

The method comprises in C2 receiving multicast packets having a respective sequence number for the communication device.

The method comprises in C3 using the sequence number of the unicast packets and the multicast packet to determine duplicate packets.

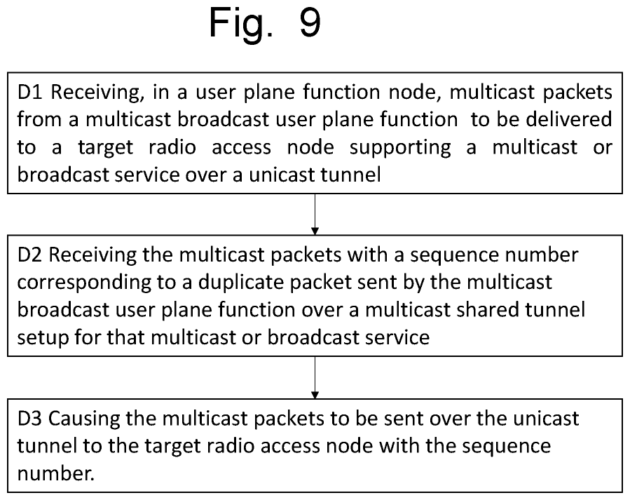

Reference is made to FIG. 9 which shows a method. The method may be performed by an apparatus. This apparatus may be as described in relation to FIG. 2. The apparatus may be provided by or in a user plane function node,

The method comprises in D1 receiving, in a user plane function node, multicast packets from a multicast broadcast user plane function to be delivered to a target radio access node supporting a multicast or broadcast service over a unicast tunnel. The method comprises in D2 receiving the multicast packets with a sequence number corresponding to a duplicate packet sent by the multicast broadcast user plane function over a multicast shared tunnel setup for that multicast or broadcast service.

The method comprises in D3 causing the multicast packets to be sent over the unicast tunnel to the target radio access node with the sequence number.

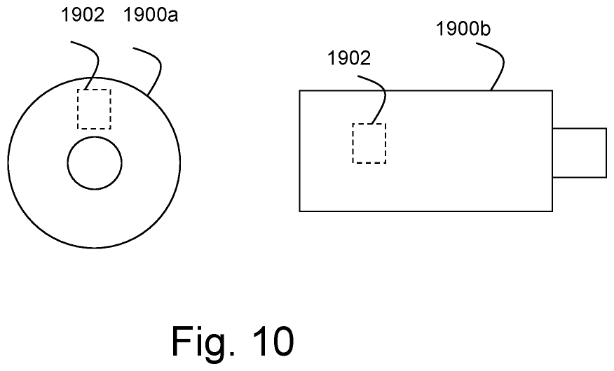

FIG. 10 shows a schematic representation of non-volatile memory media 1900a (e.g. computer disc (CD) or digital versatile disc (DVD)) and 1900b (e.g. universal serial bus (USB) memory stick) storing instructions and/or parameters 1902 which when executed by a processor allow the processor to perform one or more of the steps of the methods of FIG. 6, 7, 8 or 9.

It is noted that whilst some examples have been described in relation to 5G networks, similar principles can be applied in relation to other networks and communication systems. Therefore, although certain examples were described above by way of example with reference to certain example architectures for wireless networks, technologies and standards, examples may be applied to any other suitable forms of communication systems than those illustrated and described herein.

It is also noted herein that while the above describes examples, there are several variations and modifications which may be made to the disclosed solution without departing from the scope of the present invention.

In general, the various examples may be implemented in hardware or special purpose circuitry, software, logic or any combination thereof. Some aspects of the disclosure may be implemented in hardware, while other aspects may be implemented in firmware or software which may be executed by a controller, microprocessor or other computing device, although the disclosure is not limited thereto. While various aspects of the disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The examples of this disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out examples. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Examples in the disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The scope of protection sought for various examples of the disclosure is set out by the independent claims. The examples and features, if any, described in this specification that do not fall under the scope of the independent claims are to be interpreted as examples useful for understanding various examples of the disclosure.

The foregoing description has provided by way of non-limiting examples a full and informative description of the examples of this disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of this invention as defined in the appended claims. Indeed, there is a further example comprising a combination of one or more examples with any of the other examples previously discussed.

1. An apparatus in a source radio access node, said apparatus comprising:
at least one processor; and
at least one memory storing instructions which, when executed by the at least one processor, cause the apparatus to perform:
receiving first information for determining a last packet to be forwarded to a target radio access node to which a communications device is being handed over from the source radio access node, said source radio access node providing a multicast or broadcasting service to the communications device; and
causing the last packet to be forwarded from the source radio access node to the target radio access node with end information indicating that there no further packets are being forwarded.

2. The apparatus as claimed in claim 1, wherein the apparatus is further caused to perform for receiving at the source radio access node via a multicast shared tunnel for a multicast or broadcasting service session one or more packets to be forwarded to the target radio access node.

3. The apparatus as claimed in claim 2, wherein the apparatus is further caused to perform receiving the first information at the source radio access node via a unicast tunnel which is associated with a multicast shared tunnel corresponding to the same multicast or broadcasting service session.

4. The apparatus as claimed in claim 1, wherein the first information comprises an end marker.

5. The apparatus as claimed in claim 1, wherein the first information comprises a sequence number.

6. The apparatus as claimed in claim 1, wherein the first information comprises information indicating a first packet which is directly sent to the target radio access node.

7. The apparatus as claimed in claim 5, wherein the apparatus is further caused to perform determining a packet having a sequence number preceding a sequence number of the first packet as the last packet to be forwarded.

8. The apparatus as claimed in claim 1, wherein the end information comprises one or more end marker packets.

9. The apparatus as claimed in claim 1, wherein the target radio access node does not support a multicast or broadcast service.

10. An apparatus in a user plane function node, said apparatus comprising:
at least one processor; and
at least one memory storing instructions which, when executed by the at least one processor, cause the apparatus to perform:
receiving a first multicast packet from a multicast broadcast user plane function to be delivered to a target radio access node not supporting a multicast or broadcast service over a unicast tunnel; and
providing an end marker packet to be delivered to a source radio access node supporting a multicast or broadcast service over a unicast tunnel which is associated with a multicast shared tunnel set up for that multicast or broadcast service.

11. The apparatus as claimed in claim 10, wherein the first multicast packet is associated with a first sequence number corresponding to a sequence number of a duplicate multicast packet delivered by the multicast broadcast user plane function directly over the multicast shared tunnel.

12. The apparatus as claimed in claim 11, wherein for the apparatus is further caused to perform providing the end marker packet with information about the first sequence number.

13. A method comprising:
receiving, at a source radio access node, first information for determining a last packet to be forwarded to a target radio access node to which a communications device is being handed over from the source radio access node, said source radio access node providing a multicast or broadcasting service to the communications device; and
causing the last packet to be forwarded from the source radio access node to the target radio access node with end information indicating that there no further packets are being forwarded.

14. The method as claimed in claim 13, comprising receiving at the source radio access node one or more packets to be forwarded to the target radio access node via a multicast shared tunnel for a multicast or broadcasting service session.

15. The method as claimed in claim 13, comprising the first information at the source radio access node via a unicast tunnel which is associated with a multicast shared channel corresponding to the same multicast or broadcasting service session.

16. A method comprising:
receiving, at user plane function node, a first multicast packet from a multicast broadcast user plane function to be delivered to a target radio access node not supporting a multicast or broadcast service over a unicast tunnel; and
providing an end marker packet to be delivered to a source radio access node supporting a multicast or broadcast service over a unicast tunnel which is associated with a multicast shared tunnel set up for that multicast or broadcast service.

17. A non-transitory computer-readable medium, said computer-readable medium being encoded with computer executable instructions which when executed on at least processor causes the method of claim 13 to be performed.

18. An apparatus in a target radio access node, said apparatus comprising:
at least one processor; and
at least one memory storing instructions which, when executed by the at least one processor, cause the apparatus to perform:
receiving unicast packets having a respective sequence number, the unicast packet being associated with a unicast from a source radio access node to a communication device, the communication device being handed over from the source radio access node to the target radio access node, said target radio access node providing a multicast or broadcasting service to the communications device;
receiving multicast packets having a respective sequence number for the communication device; and
using the sequence number of the unicast packets and the multicast packets to determine duplicate packets.

19. The apparatus as claimed in claim 18, wherein the apparatus is further caused to perform determining that the communication device has been configured to receive the multicast or broadcast service and for causing the delivery of the unicast packet to be stopped.

20. The apparatus as claimed in claim 18, wherein the source radio access node does not support a multicast or broadcast service.

21. An apparatus in a user plane function node, said apparatus comprising:
at least one processor; and
at least one memory storing instruction which, when executed by the at least one processor, cause the apparatus to perform:
receiving multicast packets from a multicast broadcast user plane function to be delivered to a target radio access node supporting a multicast or broadcast service over a unicast tunnel;
receiving the multicast packets with a sequence number corresponding to a duplicate packet sent by the multicast broadcast user plane function over a multicast shared tunnel setup for that multicast or broadcast service; and
causing the multicast packets to be sent over the unicast tunnel to the target radio access node with the sequence number.

22. The apparatus as claimed in claim 21, wherein the source radio access node does not support a multicast or broadcast service.

23. The apparatus as claimed in claim 21, wherein the apparatus is further caused to perform stopping multicast packets from being sent over the unicast tunnel in response to receiving a notification from the target radio access node.

24. A method comprising:
receiving, in a target radio access node, unicast packets having a respective sequence number, the unicast packet being associated with a unicast from a source radio access node to a communication device, the communication device being handed over from the source radio access node to the target radio access node, said target radio access node providing a multicast or broadcasting service to the communications device;
receiving multicast packets having a respective sequence number for the communication device; and
using the sequence number of the unicast packets and the multicast packets to determine duplicate packets.

25. A method comprising:
receiving, in a user plane function node, multicast packets from a multicast broadcast user plane function to be delivered to a target radio access node supporting a multicast or broadcast service over a unicast tunnel;
receiving the multicast packets with a sequence number corresponding to a duplicate packet sent by the multicast broadcast user plane function over a multicast shared tunnel setup for that multicast or broadcast service; and
causing the multicast packets to be sent over the unicast tunnel to the target radio access node with the sequence number.
